(19) United States
(12) Patent Application Publication
(10) Pub. No.: US 2022/0097603 A1
(43) Pub. Date: Mar. 31, 2022

(54) DRIVER ASSISTANCE DEVICE, DRIVER ASSISTANCE METHOD, AND DRIVER ASSISTANCE SYSTEM

(71) Applicant: MITSUBISHI ELECTRIC CORPORATION, Tokyo (JP)

(72) Inventors: Jumpei HATO, Tokyo (JP); Shiori ARII, Tokyo (JP); Bunkei MATSUOKA, Tokyo (JP); Yukinori ENDO, Tokyo (JP)

(73) Assignee: MITSUBISHI ELECTRIC CORPORATION, Tokyo (JP)

(21) Appl. No.: 17/548,888

(22) Filed: Dec. 13, 2021

Related U.S. Application Data
(63) Continuation of application No. PCT/JP2019/029183, filed on Jul. 25, 2019.

(51) Int. Cl. B60Q 9/00

(52) U.S. Cl. CPC B60Q 9/00

(57) ABSTRACT

A driver assistance device to assist in giving a more appropriate stimulus to a driver is obtained. The driver assistance device includes an acquisition unit to acquire temporal change information indicating a change of a driver's arousal state over time, and a stimulus determination unit to determine a stronger stimulus as a stimulus to be given to the driver as an absolute value of the change over time indicated by the temporal change information acquired by the acquisition unit is larger.

### CROSS REFERENCE TO RELATED APPLICATIONS

This application is a Continuation of PCT International Application No. PCT/JP2019/029183 filed on Jul. 25, 2019, which is hereby expressly incorporated by reference into the present application.

### TECHNICAL FIELD

The present disclosure relates to a driver assistance device.

### BACKGROUND TECHNOLOGY

When maneuvering a vehicle or a vessel, the driver or the marine pilot should be in a proper arousal state (hereinafter, referred to as proper state) instead of in a diminished attentiveness state characterized by drowsiness or an excited state characterized by frustration. In recent years, a driver assistance device has been proposed for maintaining a driver in or inducing a driver to a proper state by constantly monitoring the state of the driver and outputting a stimulus according to the state of the driver.

For example, in Patent Document 1, it is described that amounts of sympathetic nerve activity and parasympathetic nerve activity of a driver are calculated from fluctuation in the driver's heartbeat intervals, and a stimulus is outputted according to whether the calculated amounts of sympathetic nerve activity and parasympathetic nerve activity exceed the reference values in such a way that the amounts of sympathetic nerve activity and parasympathetic nerve activity of the driver is brought closer to target values.

### PRIOR ART LITERATURE

### Patent Documents

[Patent Document 1] Japanese Patent Application Laid-Open No. 2008-125801

### SUMMARY OF THE INVENTION

### Problems to be Solved by the Invention

In the technique described in Patent Document 1, the stimulus and its intensity are adjusted according to the degrees of deviation of the amounts of autonomic nerve activities from their target values, but how a proper state has transitioned to a diminished attentiveness state or an excited state is not taken into consideration. Therefore, a strong stimulus cannot be given if the degree of deviation is small, even in a case where a strong stimulus is desirable. Such cases include when a sudden state transition into a diminished attentiveness state or an excited state occurs and when frequent state transitions into a diminished attentiveness state or an excited state occur. In other words, a stimulus for a driver is determined based only on the state of the driver at each time point, so that it is not possible, unfortunately, to give an appropriate stimulus to the driver.

The present invention is made to solve the above problem, and aims to obtain a driver assistance device that is able to assist in giving a more appropriate stimulus to the driver.

### Means for Solving the Problems

The driver assistance device according to the present disclosure includes an acquisition unit to acquire temporal change information indicating a change of a driver's arousal state over time, and a stimulus determination unit to determine a stronger stimulus as a stimulus to be given to the driver as an absolute value of the change over time indicated by the temporal change information acquired by the acquisition unit is larger.

### Effects of the Invention

The driver assistance device according to the present disclosure includes a stimulus determination unit that determines a stronger stimulus as a stimulus to be given to a driver as an absolute value of the change of the driver's arousal state over time indicated by the temporal change information is larger. Therefore, it is possible to assist in giving the driver a more appropriate stimulus in which the change of the driver's arousal state over time is considered.

### BRIEF DESCRIPTION OF THE DRAWINGS

FIG. 1 is a diagram showing a configuration of a driver assistance device 100 and a driver assistance system 1000 according to Embodiment 1.

FIG. 2 is a diagram showing a configuration example of a master matrix according to Embodiment 1.

FIG. 3 is a diagram showing a configuration example of system definition matrixes according to Embodiment 1.

FIG. 4 is a diagram showing a configuration example of a physical definition matrix according to Embodiment 1.

FIG. 5 is a diagram showing an example of a hardware configuration of the driver assistance device 100 according to Embodiment 1.

FIG. 6 is a flowchart showing an operation of the driver assistance system 1000 according to Embodiment 1 to provide driver assistance.

FIG. 7 is a diagram showing a concrete example of changes in a driver's arousal state and factors behind the changes in the arousal state.

FIG. 8 is a diagram showing a concrete example of a change of a driver's arousal level over time.

FIG. 9 is a diagram showing a configuration of a driver assistance device 100 and a driver assistance system 1000 according to Embodiment 2.

FIG. 10 is a diagram showing a concrete example of transitions and transition probabilities of a driver's arousal states.

FIG. 11 is a diagram showing a concrete example of a master matrix stored in a storage unit 3 according to Embodiment 2.

### MODES FOR CARRYING OUT THE INVENTION

### Embodiment 1

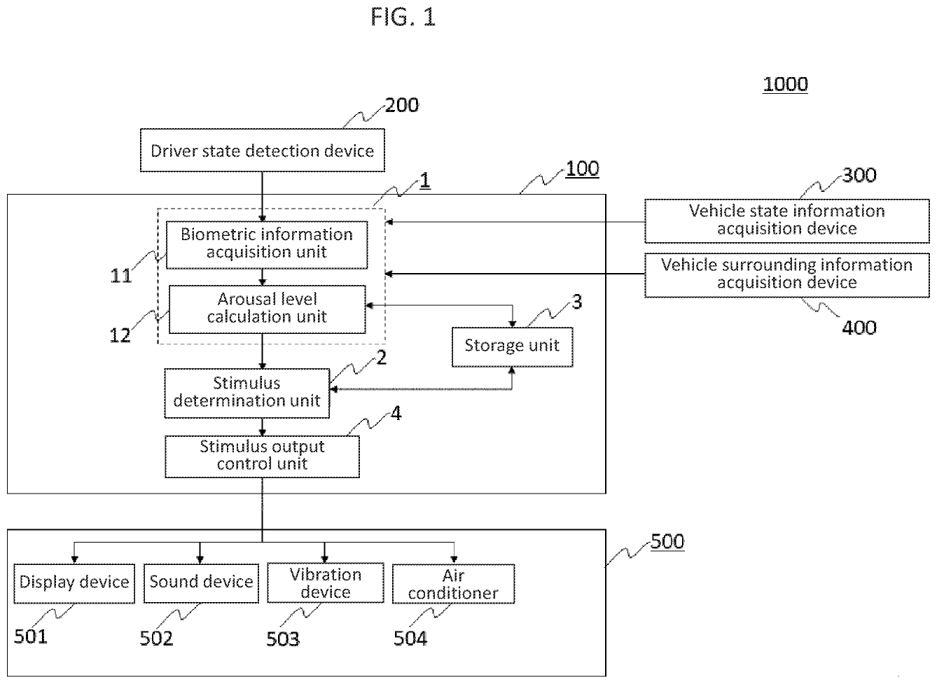

FIG. 1 is a diagram showing a configuration of a driver assistance device 100 and a driver assistance system 1000 according to Embodiment 1.

In FIG. 1, the driver assistance system 1000 includes the driver assistance device 100, a driver state detection device 200, a vehicle state information acquisition device 300, a vehicle surrounding information acquisition device 400, and a stimulus output device 500, and the driver assistance device 100 includes an acquisition unit 1, a stimulus determination unit 2, a storage unit 3, and a stimulus output control unit 4. The specific configuration of the driver assistance device 100 will be described later.

The driver state detection device 200 is a device that monitors a state of a driver to detect the driver's biometric information; examples of the device include a camera to detect information indicating a driver's state such as sweating, pupil size, complexion, facial expression, and line-of-sight from images, a pulse meter to measure driver's pulse rates, an electrocardiographic sensor to measure driver's heart rates, and an electroencephalograph to measure driver's brain waves including alpha waves and beta waves.

The vehicle state information acquisition device 300 is a device that acquires vehicle state information indicating the state of the vehicle; examples of the device include various sensors. The vehicle control information to be acquired by the vehicle state information acquisition device 300 includes, for example, a pedal pressing angle, a steering wheel rotation angle, a vehicle traveling speed, and the like. The vehicle state information acquisition device 300 only needs to be able to acquire vehicle state information; it may be configured to acquire the vehicle state information from a control signal outputted from a vehicle control device, without using a sensor or the like.

The vehicle surrounding information acquisition device 400 is a device that acquires vehicle surrounding information; examples of the device include various sensors such as a camera and a lidar. Examples of the vehicle surrounding information to be acquired by the vehicle surrounding information acquisition device 400 include road conditions such as cracks and traffic information such as congestion.

The stimulus output device 500 outputs a stimulus determined by the stimulus determination unit 2 to a driver. The details of the unit will be described later. In Embodiment 1, the stimulus output device 500 includes a display device 501 to give a stimulus to the driver's visual sense, a sound device 502 to give a stimulus to the driver's auditory sense, a vibration device 503 to give a stimulus to the driver's tactile sense, and an air conditioner 504 to give a stimulus to the driver's tactile sense and olfactory sense.

As the display device 501, for example, a head-up display capable of superimposing an output image on a background, a liquid crystal display, a light emitting diode, or the like is used. The display device 501 outputs a character, a mark, a still image, a moving image, a ray of multicolored light, or the like to stimulate the driver's visual sense.

The sound device 502 includes, for example, a speaker to output music, a spoken word, a sound effect, or the like to stimulate the driver's auditory sense.

The vibration device 503 is, for example, a moving unit installed in a driver's seat or a steering wheel to stimulate the driver's tactile sense by vibrating the seat or the steering wheel in a specific vibration pattern.

For the air conditioner 504, for example, an air conditioner for heating and cooling or a scent diffuser is used. The air conditioner 504 outputs hot air, cold air to the driver's face, neck, or back of the hands to stimulate the driver's tactile sense; the scent diffuser outputs aromatic scent to stimulate the driver's olfactory sense.

The details of the driver assistance device 100 will be described below.

The acquisition unit 1 may acquire a variety of information from the driver state detection device 200, the vehicle state information acquisition device 300, and the vehicle surrounding information acquisition device 400. Embodiment 1, however, focuses on a case in which the acquisition unit 1 acquires temporal change information indicating a change of a driver's arousal state over time from the driver state detection device 200.

Specifically, in Embodiment 1, the acquisition unit 1 includes a biometric information acquisition unit 11 and an arousal level calculation unit 12, and acquires a change rate of an arousal level over time as the temporal change information. The details of the change rate of the arousal level over time will be described later.

It is described above, as a configuration example of Embodiment 1, that the acquisition unit 1 may acquire a variety of information from the external devices: the driver state detection device 200, the vehicle state information acquisition device 300, and the vehicle surrounding information acquisition device 400, which are provided outside the driver assistance device 100. Alternatively, however, the acquisition unit 1 may be configured so as to acquire a variety of information directly. For example, the acquisition unit 1 may be configured to directly detect and acquire the driver's biometric information.

The biometric information acquisition unit 11 acquires the driver's biometric information. In Embodiment 1, the biometric information acquisition unit 11 acquires the biometric information detected by the driver state detection device 200.

The arousal level calculation unit 12 calculates the arousal level indicating the degree of the driver's arousal state and the change rate of the arousal level over time from the biometric information acquired by the biometric information acquisition unit 11.

In Embodiment 1, the arousal level calculation unit 12 calculates an amount of sympathetic nerve activity and an amount of parasympathetic nerve activity of a driver from the biometric information acquired by the biometric information acquisition unit 11, and further calculates the arousal level and the change rate of the arousal level over time based on the amount of sympathetic nerve activity and the amount of parasympathetic nerve activity calculated. In Embodiment 1, the arousal level is defined as the amount of sympathetic nerve activity divided by the amount of parasympathetic nerve activity. When the arousal state of a driver is a proper state, the amount of sympathetic nerve activity and the amount of parasympathetic nerve activity are in equilibrium, and the arousal level at this moment is stored in the storage unit 3 as a reference value.

As for a method of calculating and setting the reference value, for example, an arousal level calculated from the biometric information obtained from a driver being at rest with the eyes closed during a predetermined time before starting driving may be set as the reference value.

Here, the amount of sympathetic nerve activity, which increases when a driver's sympathetic nerve becomes active, is calculated from the low-frequency components of the driver's heartbeats, the driver's brain waves such as beta waves and gamma waves, and the driver's angry facial expressions. The amount of parasympathetic nerve activity, which increases when a driver's parasympathetic nerve becomes active, is calculated from the high-frequency components of the driver's heartbeats, the driver's brain waves such as alpha waves and theta waves, and the driver's relaxed facial expressions.

The stimulus determination unit 2 is a unit that determines a stronger stimulus as a stimulus to be given to a driver as the absolute value of change over time indicated by the temporal change information acquired by the acquisition unit 1 is larger. In Embodiment 1, the stimulus determination unit 2 determines a stronger stimulus as a stimulus to be given to a driver as the absolute value of the change rate of an arousal level over time calculated by the arousal level calculation unit 12 is larger. In Embodiment 1, the stimulus to be given to a driver is determined based on stimulus correspondence information stored in the storage unit 3, which will be described later.

More specifically, in Embodiment 1, the stimulus determination unit 2 determines to give a positive stimulus to a driver when the arousal level calculated by the arousal level calculation unit 12 remains lower than a predetermined threshold L1 during a predetermined time Tt1 with the driver's arousal state having been changed from a proper state to a diminished attentiveness state. Here, the positive stimulus is a stimulus that raises the arousal level of a driver by activating the sympathetic nerve, and aims to induce the driver from a diminished attentiveness state to a proper state. Also, the stimulus determination unit 2 determines a stimulus to be given to a driver based on the absolute value of the change rate of the arousal level over time during a predetermined time ΔT1 before and after the driver's arousal state changes from a proper state to a diminished attentiveness state.

Similarly, the stimulus determination unit 2 determines to give a negative stimulus to a driver when the arousal level calculated by the arousal level calculation unit 12 remains higher than a predetermined threshold L2 during a predetermined time Tt2 with the driver's arousal state having been changed from a proper state to an excited state. Here, the negative stimulus is a stimulus lowers the arousal level of a driver by activating the parasympathetic nerve, and aims to induce the driver from an excited state to a proper state. Also, the stimulus determination unit 2 determines a stimulus to be given to a driver based on the change rate of the arousal level over time during a predetermined time ΔT2 before and after the driver's arousal state changes from a proper state to an excited state.

Table 1 shows examples of positive and negative stimuli to be given to a driver.

In Table 1, the row headings indicate the types of senses to which a stimulus is given, the column headings indicate whether the stimulus is positive or negative, and each cell includes concrete examples of the stimuli to be given. For example, as a positive stimulus to the visual sense, which is effective for activating the sympathetic nerve, a warm, bright and clear-colored light or characters are displayed on a predetermined display device in a specific display pattern. As a positive stimulus to the auditory sense, up-tempo and high-pitched music or utterance with words of question are outputted from a speaker. Each stimulus may be outputted independently, or stimuli for a plurality of senses may be outputted at once.

TABLE 1

| | <Positive Stimuli> | <Negative Stimuli> |
|---|---|---|
| | Examples of stimuli for | Examples of stimuli for |
| | raising arousal | lowering arousal |
| | level by activating | level by activating |
| | sympathetic nerve | parasympathetic nerve |
| Visual | Hue: red, yellow, green | Hue: cyan, blue, magenta |
| sense | Saturation: high, pure color | Saturation: low, achromatic |
| | Lightness: bright | (white/black/gray) |
| | Color temperature: warm, | Lightness: dark |
| | daylight | Color temperature: cold, light |
| | Illuminance: bright, close | bulb color |
| | to light source | Illuminance: dark, away from |
| | Indication to give sense of | light source |
| | openness and acceleration | Indication to give sense of |
| | Indication to give sense of | pressure or deceleration |
| | being approached by object | |
| Auditory | High-pitched, up-tempo, | Low-pitched, slow tempo, |
| sense | strong (>60 dB) | weak (<45 dB) |
| | Music: pops, rock | Music: classical, jazz |
| | Words: questioning, | Words: affirmative, empathetic |
| | encouraging, appreciative | Pseudo-sound: vanishing |
| | Pseudo-sound: approaching | sound, decelerating sound, |
| | sound, accelerating sound, | natural sound (healing |
| | artificial sound | taste) |
| Tactile | Uncomfortable vibration, | Comfortable vibration, long- |
| sense | short-period vibration | period vibration |
| | Intermittent/random | Simple harmonic vibration |
| | vibration (seat, | (seat, steering wheel, etc.) |
| | steering wheel, etc.) | |
| Olfactory | Cold air to face, neck, and | Comfortable warm air to face, |
| sense | back of hand, etc. | neck, back of hand, etc. |
| | Aromatic (refreshing) scent | Aromatic (relaxing) scent |

The storage unit 3 is a unit that stores the stimulus correspondence information that associates a change of a driver's arousal state over time with a stimulus to be given to a driver. In this stimulus correspondence information, the changes of driver's arousal state over time are classified into a plurality of stages, and a stage for a larger absolute value of the change of a driver's arousal state over time is associated with a stronger stimulus.

In Embodiment 1, the storage unit 3 stores stimulus matrixes, which are matrix tables in which change rates of the arousal level over time and the stimuli to be given to a driver are associated with each other as the stimulus correspondence information.

Also, in Embodiment 1, the storage unit 3 stores the following thresholds and times: the threshold L1 of the arousal level for determining whether the driver's arousal state changes from a proper state to a diminished attentiveness state; the threshold L2 of the arousal level for determining whether the driver's arousal state changes from a proper state to an excited state; time Tt1 for the stimulus determination unit 2 to determine whether the driver's arousal state does not return to a proper state after changing from a proper state to a diminished attentiveness state; the predetermined time ΔT1 for the stimulus determination unit 2 to consider the arousal level in determining a positive stimulus to be given to the driver; time Tt2 for the stimulus determination unit 2 to determine whether the driver's arousal state does not return to a proper state after changing from a proper state to an excited state; the predetermined time ΔT2 for the stimulus determination unit 2 to consider the arousal level in determining a negative stimulus to be given to the driver; time To1 for the stimulus output device 500 to output a positive stimulus; and time Tot for the stimulus output device 500 to output a negative stimulus.

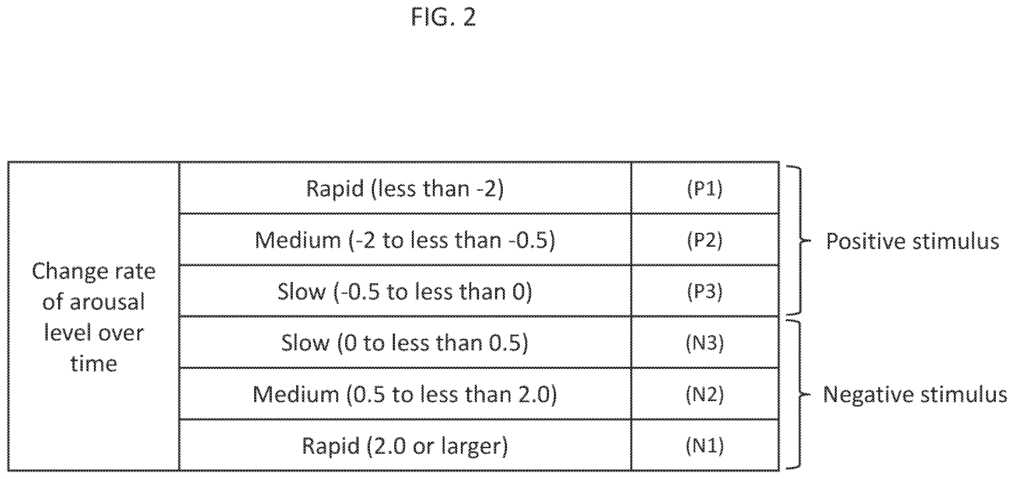

FIGS. 2 to 4 are diagrams showing configuration examples of the stimulus matrixes.

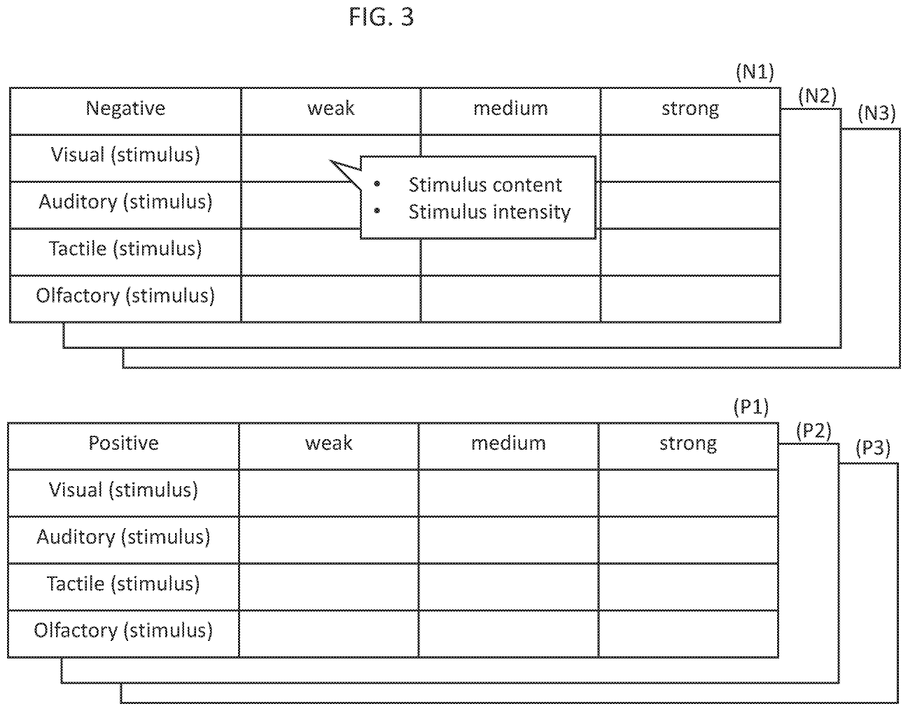

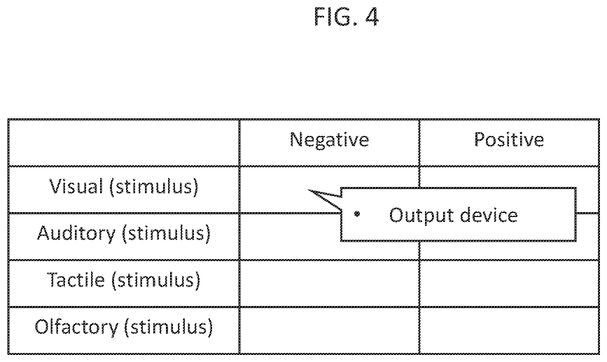

The stimulus matrixes hold stimulus information that indicates the stimuli to be given to a driver. In Embodiment 1, the stimulus matrixes include a master matrix, system definition matrixes, and physical definition matrix. FIG. 2 shows a configuration example of the master matrix, FIG. 3 shows a configuration example of the system definition matrixes, and FIG. 4 shows a configuration example of the physical definition matrix. The stimulus information includes pointer information, stimulus content information, and device information, which will be described later.

As shown in FIG. 2, the master matrix classifies the change rates of the arousal level into a total of six stages, namely “slow,” “medium,” and “rapid,” for each of positive and negative ranges, and holds pointer information to associate each stage with the system definition matrixes.

As shown in FIG. 3, the system definition matrixes hold the stimulus content information that indicates stimulus content to be given to a driver according to a system specification. Specifically, the system definition matrixes include six matrixes indicated by their respective pointer information in the master matrix. In each system definition matrix, the row headings indicate the types of senses to which the stimulus is given, and the column headings indicate the intensities of stimulus in three levels: “weak,” “medium,” and “strong”. Each cell holds the stimulus content information that indicates the specific stimulus content, such as a stimulus type, a stimulus intensity, and a stimulus output pattern.

Negative stimuli are defined in the matrixes N1 to N3, and positive stimuli are defined in the matrixes P1 to P3. Also, in Embodiment 1, only negative stimuli in the column of “strong” are defined in the matrix N1, only negative stimuli in the column of “medium” are defined in the matrix N2, and only negative stimuli in the column of “weak” are defined in the matrix N3. Similarly, only positive stimuli in the column of “strong” are defined in the matrix P1, only positive stimuli in the column of “medium” are defined in the matrix P2, and only positive stimuli in the column of “weak” are defined in the matrix P3.

As shown in FIG. 4, the physical definition matrix holds the device information indicating devices that output stimuli based on a physical specification of each vehicle. Specifically, the row headings indicate the types of senses to which stimuli are given, the column headings indicate whether the stimuli are negative or positive, and each cell holds information on a device that outputs each of the stimuli.

In FIG. 1 again, the stimulus output control unit 4 is a unit that transmits a control signal to make the stimulus output device 500 output the stimulus determined by the stimulus determination unit 2. For example, in Embodiment 1, the stimulus output control unit 4 outputs to the display device 501 a control signal for the stimulus determined by the stimulus determination unit 2 to the driver's visual sense, the control signal indicating how much brightness should be outputted, how much voltage should be given and the like. Similarly, in Embodiment 1, the stimulus output control unit 4 outputs a control signal for outputting an appropriate stimulus, to the sound device 502, the vibration device 503, and the air conditioner 504.

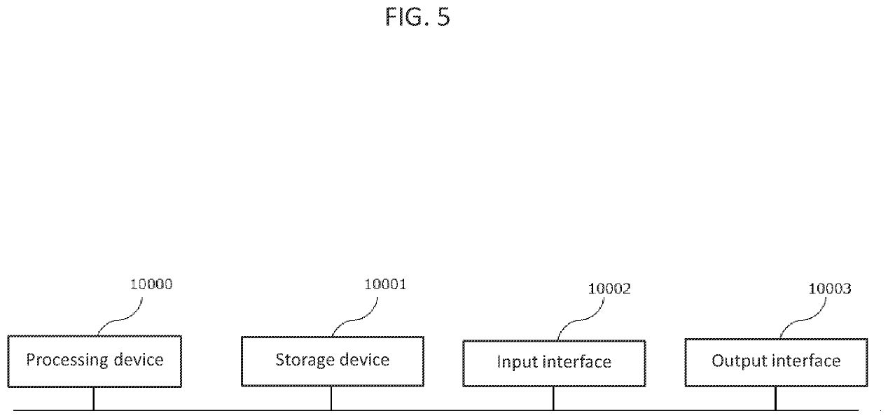

Each function of the driver assistance device 100 is realized by a computer. FIG. 5 is a diagram showing an example of a hardware configuration of a computer that realizes the driver assistance device 100.

The hardware shown in FIG. 5 includes a processing device 10000 such as a central processing unit (CPU), a storage device 10001 such as a read only memory (ROM) and a hard disk, an input interface 10002, and an output interface 10003.

The stimulus determination unit 2 shown in FIG. 1 is realized when a program stored in the storage device 10001 is executed by the processing device 10000. The acquisition unit 1 is realized by the input interface 10002. The input interface 10002 has a function of transferring an electric signal inputted from an external device such as the driver state detection device 200 to the processing device 10000. The stimulus output control unit 4 is realized by the output interface 10003. The output interface 10003 outputs an electric signal for controlling the stimulus output device 500 according to a command from the processing device 10000.

The method of realizing each function of the stimulus determination unit 2 is not limited to the above-mentioned configuration in which hardware and a program are combined. Each function may be realized only by hardware, such as a large scale integrated circuit (LSI) in which a program is implemented. It is also possible to realize some of the functions with dedicated hardware and others with a combination of the processing device and a program.

The driver assistance device 100 and the driver assistance system 1000 are configured as described above.

Next, the operation of the driver assistance device 100 and the driver assistance system 1000 will be described.

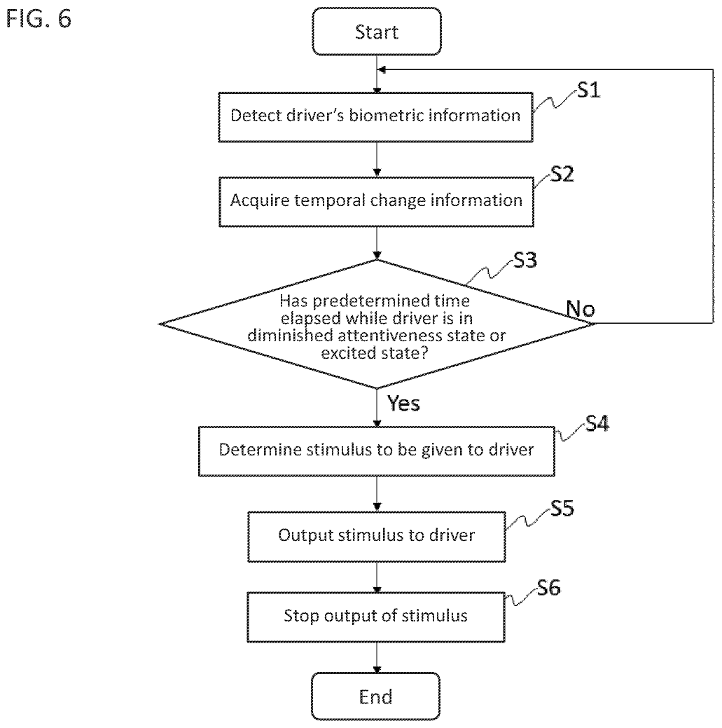

FIG. 6 is a flowchart showing an operation of the driver assistance system 1000 to provide driver assistance. The operation of the driver assistance system 1000 to provide driver assistance corresponds to the driver assistance method; step S2 corresponds to an acquisition step in the driver assistance method; and step S4 corresponds to a stimulus determination step. The program that makes the computer execute the driver assistance method is the driver assistance program.

When the driver assistance system 1000 starts operating, in step S1, the driver state detection device 200 detects the driver's biometric information and transmits it to the biometric information acquisition unit 11. The vehicle state information acquisition device 300 acquires the vehicle state information, and the vehicle surrounding information acquisition device 400 acquires the vehicle surrounding information. The information acquired is transmitted to the acquisition unit 1.

Next, in step S2, the acquisition unit 1 acquires the temporal change information indicating the change of the driver's arousal state over time.

Specifically, the arousal level calculation unit 12 calculates the driver's arousal level and the change rate of the arousal level over time from the biometric information acquired by the biometric information acquisition unit 11. The acquisition unit 1 acquires the change rate of the arousal level over time calculated by the arousal level calculation unit 12 as the temporal change information.

Next, in step S3, the stimulus determination unit 2 determines whether the arousal level calculated by the arousal level calculation unit 12 is lower than the predetermined threshold L1, being a first threshold, or higher than the predetermined threshold L2, being a second threshold. Further, the stimulus determination unit 2 determines whether the driver stays in a diminished attentiveness state or an excited state for a predetermined time or longer, and if the time when the driver is in either of these states exceeds the predetermined time, the stimulus determination unit 2 determines to give a stimulus to the driver. That is, it is determined whether either the time when the arousal level is lower than the threshold L1 or the time when the arousal level is higher than the threshold L2 exceeds a predetermined time; and if it is determined that either of the times exceeds the predetermined time, it is determined to give a stimulus to the driver. If the arousal level is higher than or equal to the threshold L1 and lower than or equal to the threshold L2, if the time when the arousal level is lower than the threshold L1 does not exceed a predetermined time, or if the time when the arousal level is higher than the threshold L2 does not exceed a predetermined time, the operation returns to step S1 and detects the driver's biometric information again.

Next, in step S4, the stimulus determination unit 2 determines a stronger stimulus as a stimulus to be given to the driver as the absolute value of the change over time indicated by the temporal change information acquired in step S2 is larger.

Specifically, first, the stimulus determination unit 2 acquires from the master matrix the pointer information that indicates the system definition matrix based on the arousal level and the change rate of the arousal level of the driver over time. In detail, if the driver's arousal level is lower than the threshold L1, the stimulus determination unit 2 acquires one of the pointer information items P1 to P3; if the driver's arousal level is higher than threshold L2, the stimulus determination unit 2 acquires one of the pointer information items N1 to N3. Here, as the absolute value of the change rate of the arousal level of the driver over time is larger, the pointer information that indicates the system definition matrix defining a stronger stimulus is acquired. For example, as shown in FIG. 2, when the change rate of the arousal level over time is 1.5, the pointer information indicating N2 is acquired.

As shown in FIG. 3, the stimulus determination unit 2 determines a stimulus to be given to the driver by referring to a column of the system definition matrix indicated by the pointer information. Here, in the system definition matrix of N2, as it is assumed that stimuli are defined only in the middle column, a stimulus to be given to the driver is determined by referring to each cell in the middle column.

Further, as shown in FIG. 4, the stimulus determination unit 2 acquires from the physical definition matrix the information on the devices to output the stimulus, and transmits to the stimulus output control unit 4 the information on the device to output the stimulus and the information on the stimulus to be given to the driver together.

Next, in step S5, the stimulus output control unit 4 transmits a control signal for outputting the stimulus to the stimulus output device 500 based on the stimulus information determined by the stimulus determination unit 2. The stimulus output device 500 gives the stimulus to the driver based on the control signal from the stimulus output control unit 4.

In step S6, the stimulus output device 500 stops the output of the stimulus, and the driver assistance system 1000 ends its operation. Here, regarding when to stop the output of a stimulus, the stimulus output device 500 may stop it after outputting it for a predetermined time or when the stimulus determination unit 2 detects that the driver's arousal state returns to a proper state.

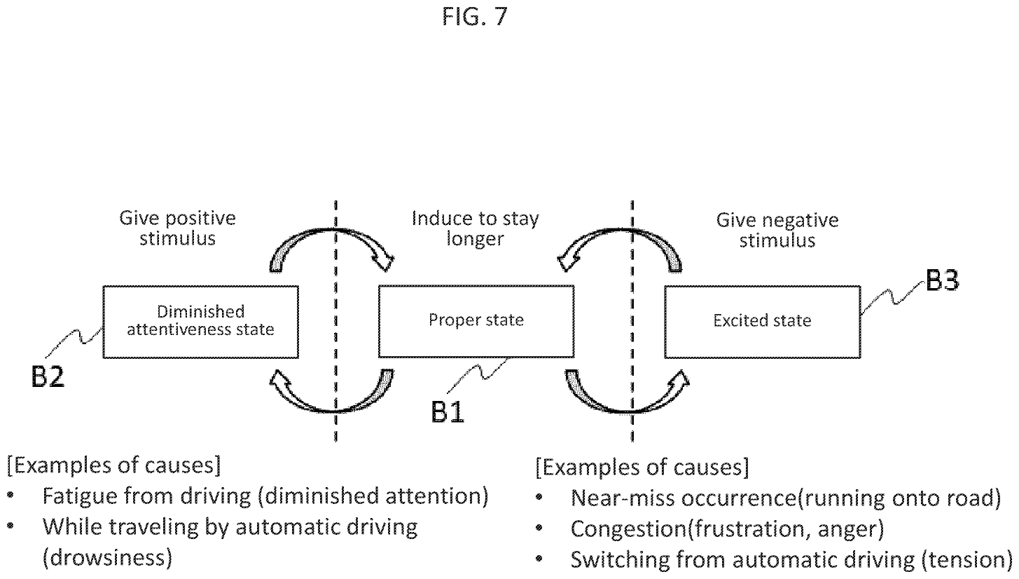

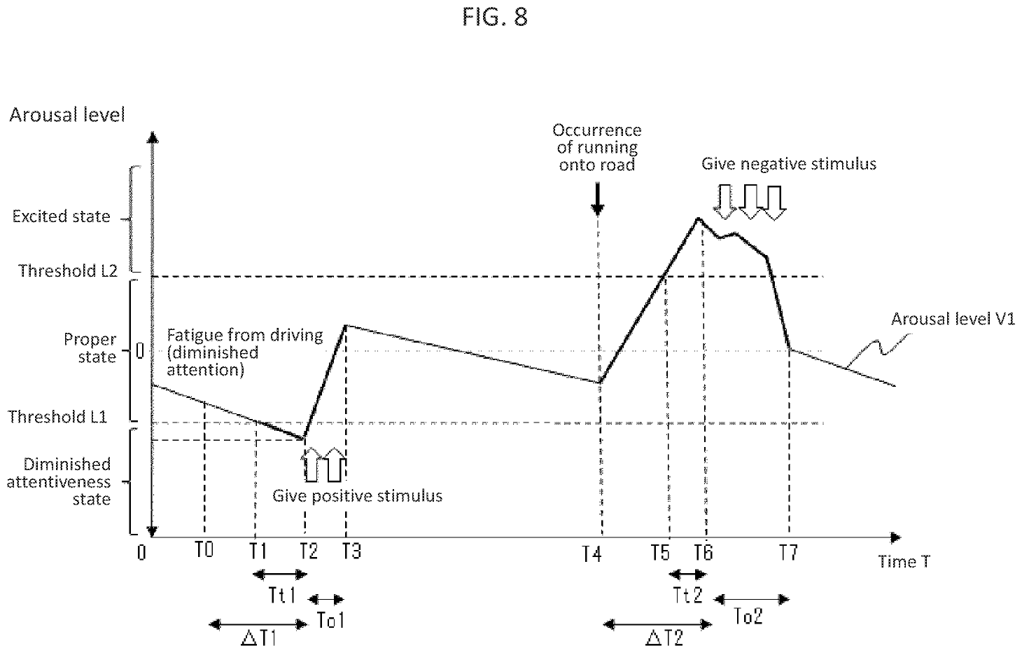

The concrete example of the operation performed by the driver assistance device 100 and the driver assistance system 1000 will be described in detail below with reference to FIGS. 7 and 8.

FIG. 7 is a diagram showing concrete examples of changes in a driver's arousal state and the causes thereof.

Of the three blocks illustrated in FIG. 7, the centrally-located proper state B1 is a state in which the sympathetic nerve activity and the parasympathetic nerve activity are working equally actively, where the driver's concentration and judgment are in good condition. The diminished attentiveness state B2, which is located on the left side of the proper state, is a state in which the parasympathetic nerve activity is predominant over the sympathetic nerve activity. Examples of the causes of transition from a proper state to a diminished attentiveness state during driving include fatigue due to long-time driving and occurrence of drowsiness during automatic driving. The excited state B3, which is located on the right side of the proper state, is a state in which the sympathetic nerve activity is predominant over the parasympathetic nerve activity. Examples of the causes of a transition from a proper state to an excited state during driving include a near-miss occurrence due to a sudden running of someone onto a road, a frustration due to traffic congestion, and a tension due to switching from automatic driving to manual driving.

The driver assistance system 1000 outputs a positive stimulus when the driver's arousal state is the diminished attentiveness state B2, and outputs a negative stimulus when the driver's arousal state is the excited state B3, thereby inducing the driver's arousal state to be a proper state for a long time.

FIG. 8 is a diagram showing a concrete example of the change of the arousal level of a driver over time.

In FIG. 8, the vertical axis shows the driver's arousal level, and the horizontal axis shows the time. In the region where the arousal level is lower than the threshold L1, the driver is in a diminished attentiveness state in which the parasympathetic nerve activity is dominant; in the region where the arousal level is higher than or equal to the threshold L1 and lower than or equal to the threshold L2, the driver is in a proper state in which the parasympathetic nerve activity and the sympathetic nerve activity are balanced; and in the region where the arousal level is higher than the threshold L2, the driver is in an excited state in which the sympathetic nerve activity is dominant.

Starting from time T=0, the driver's attention is gradually decreasing due to fatigue from driving. During this time, the arousal level V1 of the driver gradually decreases, and at time T1, it falls below the threshold L1. After that, the predetermined time Tt1 has passed, and the driver's arousal level remains below the threshold L1 even at time T2, so that the stimulus determination unit 2 determines to give a positive stimulus to the driver. The stimulus determination unit 2 determines a positive stimulus to be given to the driver from the stimulus matrixes based on the change rate of the arousal level over time during the predetermined time ΔT1 (time from time T0 to time T2 in this embodiment) before and after the driver's arousal state changes from a proper state to a diminished attentiveness state. The stimulus output device 500 outputs a stimulus determined by the stimulus determination unit 2 to the driver during the period from time T2 to time T3 (predetermined time To1). The driver's arousal state returns to a proper state, and the driver assistance system 1000 stops outputting a positive stimulus to the driver.

Here, for example, ΔT1 may be set to twice the time Tt1. By setting ΔT1 in this way, the temporal change information before and after a driver's arousal level falls below the threshold L1 can be treated equally. To emphasize either the time periods before or after the arousal level falls below the threshold L1, the weighting may be performed accordingly, instead of doubling the time Tt1.

After that, the driver continues to drive in a proper state, but at time T4, disturbance due to occurrence of pedestrian's running onto the road makes the driver's arousal level V1 soar and exceed the threshold L2 at time T5, when the driver falls into an excited state. After the arousal level V1 exceeds the threshold L2 at time T5, the predetermined time Tt2 elapses; then, even at time T6, the arousal level remains above the threshold L2, so that the stimulus determination unit determines to give a negative stimulus to the driver. The stimulus determination unit 2 determines a negative stimulus to be given to the driver from the stimulus matrixes based on the change rate of the arousal level over time during the predetermined time ΔT2 (time from time T4 to time T6 in this embodiment) before and after the driver's arousal state changes from a proper state to an excited state. The driver assistance system 1000 outputs a stimulus determined by the stimulus determination unit 2 to the driver during the period from time T6 to time T7 (predetermined time To2). The driver's arousal state returns to a proper state, and the driver assistance system 1000 stops outputting a negative stimulus to the driver.

Here, for example, ΔT2 may be set to a time from time T4, when the change rate of the arousal level over time changes from negative to positive, to the time when the predetermined time Tt2 elapses after the arousal level exceeds the threshold L2. With such a setting, it is possible to take a sharp rise in the arousal level into proper consideration. Alternatively, similarly to the setting of ΔT1, ΔT2 may be set as a predetermined multiple of Tt2.

Here, regarding the timing at which the driver assistance system 1000 stops the output of a stimulus, as described above, the output of the stimulus may be stopped when a predetermined time elapses from the start of the output of the stimulus or when the transition of the driver's arousal state to a proper state is detected. In FIG. 8, the arousal level gradually declines from time T3 to time T4, and rises sharply after a near-miss occurred at T4. When the arousal level changes abruptly, as described above, between before and after a certain time T4, the stimulus determination unit 2 should use the change rate of the arousal level over time after the certain time T4 to determine a stimulus to be given to the driver. Also, regarding the predetermined times ΔT1 and ΔT2 to be used by the stimulus determination unit 2 to determine a stimulus, the change rate of the arousal level over time within each of these predetermined times should not fluctuate much, or should be almost constant.

The following describes modified examples of the driver assistance device 100 and the driver assistance system 1000 in Embodiment 1.

In the master matrix, the change rates of the arousal level over time are classified into a total of six stages ranging from positive to negative, but the change rate may be classified into five or less stages or seven or more stages.

Further, it is described that the stimulus determination unit 2 determines, using the master matrix and the system definition matrixes, a stimulus to be given to a driver from the change rates of the arousal level over time classified into a total of six stages ranging from positive to negative. Instead, however, the stimulus determination unit 2 may determine a stimulus in such a way that its intensity increases continuously as the absolute value of the change rate of the arousal level over time increases.

By classifying the arousal level into seven or more stages or by making the change of the intensity of a stimulus continuous, it is possible to determine and provide stimuli that are more finely tuned to the driver's arousal state.

It is described that the system definition matrixes stored in the storage unit 3 hold the stimulus content information in only one column in each of the matrixes P1 to P3 and N1 to N3. Instead, however, the stimulus content information may be held in the other columns as well. In that case, for example, from which column in each matrix the content of a stimulus is to be selected may be determined based on the vehicle state information and the vehicle surrounding information. By defining the stimulus content information in this way, it is possible to give a more appropriate stimulus to a driver by considering not only the driver's state but also the vehicle's state and the vehicle's surrounding environment.

In this case, in the situation where all the information, except the temporal change information indicating the change of a driver's arousal state over time, is the same, regarding positive stimuli, the contents of stimuli are determined in a way that the stimuli defined in the matrix P1 will have the highest intensity and the stimuli defined in the matrix P3 will have the lowest intensity. Similarly, regarding negative stimuli, the contents of stimuli are set in a way that the stimuli defined in the matrix N1 will have the highest intensity and the stimuli defined in the matrix N3 will have the lowest intensity. For example, when determining, as described above, from which column in each matrix the content of a stimulus is to be selected based on the vehicle state information and the vehicle surrounding information, the intensities of the stimuli defined in the column of “Low” of the matrix N1 may be lower than the intensities of the stimuli defined in the column of “High” in the matrix N2. However, when the column of “High” of the matrix N1 and the column of “High” of the matrix N2 are compared, in other words, in comparison between the same columns from the two matrixes, the contents of the stimuli are to be set in a way that the intensities of the stimuli of the matrix N1 will be higher than the intensities of the stimuli of the matrix N2.

It is described that the stimulus determination unit 2 determines to give a stimulus to a driver when a predetermined time elapses after the arousal level exceeds, or falls below, a threshold. However, the stimulus determination unit 2 may determine to give a stimulus immediately after the arousal level exceeds, or falls below, a threshold. By providing a predetermined time before determining to give a stimulus to a driver, if the driver returns to a proper state without the stimulus, the driver will not receive the stimulus and thus will not be annoyed thereby. On the other hand, if giving of a stimulus to a driver is determined immediately after a threshold is exceeded above or below, the responsiveness to the driver's state can be improved because the stimulus can be given to the driver quickly.

It is described that the stimulus determination unit 2 determines a stimulus to be given to a driver based on the absolute value of change rate over time indicated by the temporal change information covering a predetermined time “before and after” the driver's arousal state changes either from a proper state to an excited state or from a proper state to a diminished attentiveness state. However, the predetermined time used here may not cover both of “before and after” the state change, but may cover only either “before” or “after” the state change. For example, when a stimulus is to be determined immediately after a threshold is exceeded, the stimulus can be determined more quickly by using the temporal change information immediately before the state change; when a stimulus is to be determined after a predetermined time elapses, the stimulus in which the most recent arousal state is considered can be determined by using the temporal change information after the state change. Also, as for the absolute value of the change rate of the arousal level over time in a predetermined time, for example, the absolute value of the change rate over time calculated from the arousal levels at the start time and the end time of the predetermined time or the average of the absolute values of the change rates of the arousal level over time at each time point during the predetermined time may be used.

It is described that the stimulus output control unit 4 controls the stimulus output device 500 in such a way that it continues to output a stimulus for a predetermined time. Instead, however, the stimulus output control unit 4 may control the stimulus output device 500 to stop the output of a stimulus when the driver's arousal state returns to a proper state or when the driver's arousal state is detected to transition toward a proper state even when it is still in an excited state or a diminished attentiveness state. Here, the state to transition toward a proper state means, for example, that the arousal level of the driver currently in an excited state is continuously negative for a predetermined time, or the arousal level of a driver currently in a diminished attentiveness state is continuously positive for a predetermined time. Alternatively, if there is minute fluctuation in the driver's arousal level, whether the driver's arousal state is transitioning toward a proper state may be determined based on whether the arousal level which has undergone predetermined processing such as moving average, not the arousal level itself, is continuously negative or positive for a predetermined time.

The arousal level calculation unit 12 continuously calculates a driver's arousal level based on the biometric information acquired by the biometric information acquisition unit 11; however, the arousal level calculation unit 12 may be configured not to calculate the arousal level if it is not necessary to give a stimulus to the driver depending on the driving conditions of the vehicle or the like. For example, the arousal level calculation unit 12 may be configured not to calculate an arousal level and the driver assistance device 100 may be configured not to perform any further operation when the acquisition unit 1 acquires, in step S2, information indicating that the vehicle is stopped from the vehicle state information acquisition device 300.

The driver assistance system 1000 may be configured with an emergency control unit (not shown), which transmits a control signal for decelerating or stopping the vehicle to a vehicle control unit (not shown) when the driver's arousal state does not recover to a proper state even if a stimulus is continuously outputted. For example, the emergency control unit may transmit a control signal to the vehicle control unit to stop the vehicle when the arousal level calculated by the arousal level calculation unit 12 is lower than the threshold L1 or higher than the threshold L2 even if the stimulus output device 500 outputs a stimulus a predetermined number of times.

As described so far, the driver assistance device 100 according to Embodiment 1 makes it possible to give to a driver a more appropriate stimulus in which the change of the driver's arousal state over time is considered by determining a stronger stimulus as a stimulus to be given to the driver as the absolute value of the change of the driver's arousal state over time indicated by the temporal change information is larger. Therefore, the driver assistance system can assist in giving the driver a more appropriate stimulus in which the change of the driver's arousal state over time is considered.

For example, if a driver's arousal level suddenly jumps up into an excited state, it is an immediate action to be taken to pull it back to a proper state by giving a strong stimulus immediately after the threshold L2 is exceeded. However, in a case when the intensity of a stimulus is determined based only on the arousal level, the difference between the threshold L2 and the arousal level is still small immediately after the threshold L2 is exceeded, so that a strong stimulus is not selected as a stimulus to be given to the driver. In contrast, in the driver assistance device 100 according to Embodiment 1, the larger the absolute value of the change rate of the arousal level over time is, the stronger the stimulus determined as a stimulus to be given to a driver is. Therefore, the driver assistance device 100 is quicker to determine a stronger stimulus than in the case where the determination of a stimulus is made based only on the arousal level. In other words, at the same time point immediately after the threshold L2 is exceeded, it is possible to determine a stronger stimulus than in the case where only the arousal level is used for the stimulus determination.

To the contrary, if an excessively strong stimulus is given while a driver's state is gradually transitioning from a proper state to a diminished attentiveness state, the driver's state may pass through a proper state to be pushed up into an excited state. The driver assistance device 100 according to Embodiment 1 can prevent the giving of an excessively strong stimulus as described above by determining a stimulus to be given to a driver considering the change of the arousal state over time.

In addition, the driver assistance device 100 in Embodiment 1 uses the absolute value of the change rate of the arousal level over time as the temporal change information, and the larger the absolute value is, the stronger the stimulus determined as a stimulus to be given to a driver is. This makes it possible to quantitatively evaluate the degree of an arousal state of a driver and give an appropriate stimulus to the driver.

In the case where a driver's arousal state changes from a proper state to an excited state, the driver assistance device 100 according to Embodiment 1 determines a stimulus to be given to a driver based on the absolute value of the change over time indicated by the temporal change information in a predetermined time before and after the driver's arousal state changes from the proper state to the excited state. In the case where a driver's arousal state changes from a proper state to a diminished attentiveness state, the driver assistance device 100 according to Embodiment 1 determines a stimulus to be given to a driver based on the absolute value of the change over time indicated by the temporal change information in a predetermined time before and after the driver's arousal state changes from the proper state to the diminished attentiveness state. This makes it possible to select a more appropriate stimulus for a driver's state than to select a stimulus based on the temporal change information over the entire time span.

In addition, the driver assistance device 100 in Embodiment 1 includes the storage unit 3 to store the stimulus correspondence information that associates the changes of a driver's arousal state over time with the stimuli to be given to the driver. The stimulus determination unit 2 determines a stimulus or stimuli to be given to the driver based on the stimulus correspondence information stored in the storage unit 3. This makes it possible to determine the stimulus contents by flexibly setting the types, combinations, intensities, patterns, and the like of the stimuli using the stimulus correspondence information, thereby effectively inducing the driver's arousal state from a diminished attentiveness state or an excited state to a proper state.

### Embodiment 2

Next, Embodiment 2 of the present disclosure will be described.

The description of the same configuration and operation as in Embodiment 1 will be omitted.

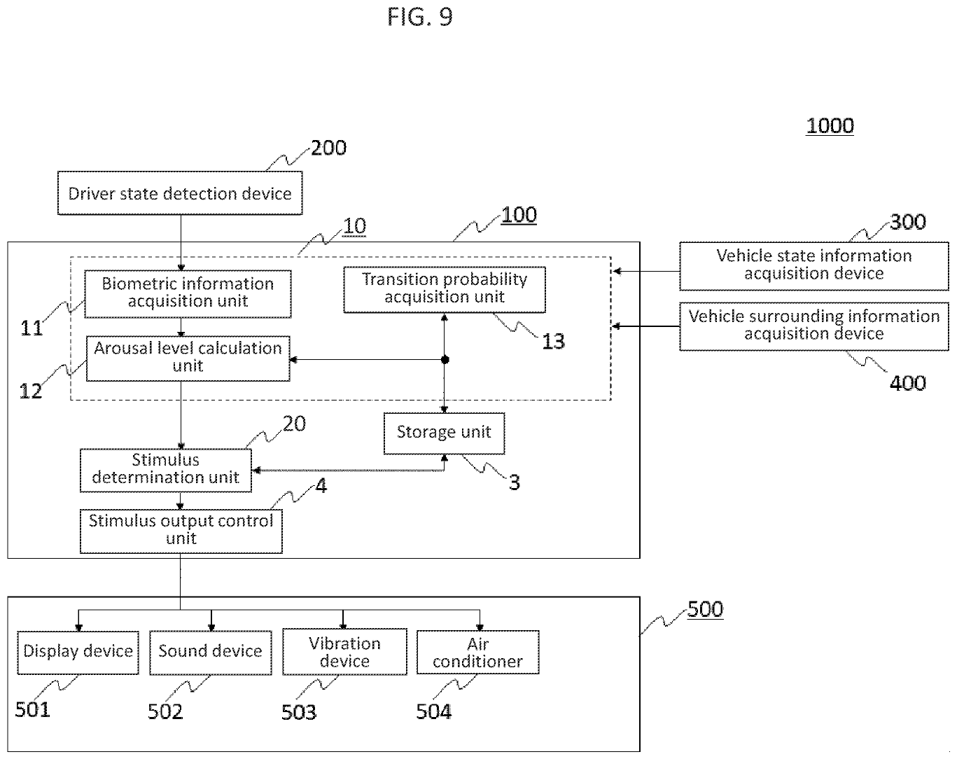

FIG. 9 is a diagram showing a configuration of a driver assistance device 100 and a driver assistance system 1000 according to Embodiment 2.

In Embodiment 1, it is described that the acquisition unit 1 acquires the change rate of the arousal level over time as the temporal change information and the stimulus determination unit 2 determines a stronger stimulus as a stimulus to be given to a driver as the absolute value of the change rate of the arousal level over time is larger. In contrast, in Embodiment 2, an acquisition unit 10 acquires a transition probability of a driver's arousal state as the temporal change information, and a stimulus determination unit 20 determines a stronger stimulus as a stimulus to be given to the driver as the transition probability acquired by the acquisition unit 10 is higher.

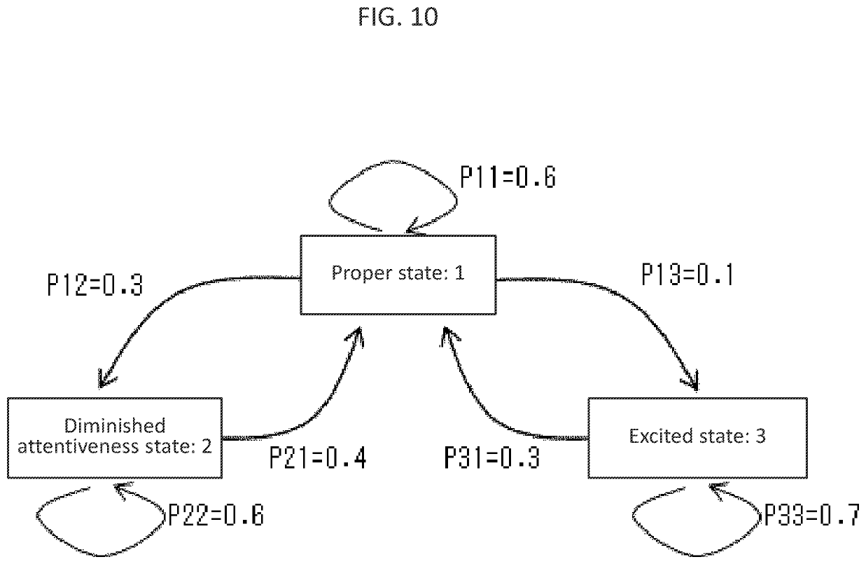

FIG. 10 is a diagram showing a concrete example of transitions and transition probabilities of a driver's arousal states.

In FIG. 10, the driver's arousal state is classified into three states: a diminished attentiveness state, a proper state, and an excited state; and the transitions between the states expected to occur during a predetermined time are indicated by arrows along with their respective probabilities.

In Embodiment 2, the acquisition unit 10 includes the biometric information acquisition unit 11, the arousal level calculation unit 12, and a transition probability acquisition unit 13. The biometric information acquisition unit 11 and the arousal level calculation unit 12 have the same functions as those in Embodiment 1.

Further, in Embodiment 2, the storage unit 3 stores transition probability information indicating the transition probabilities between the states, and the transition probability acquisition unit 13 acquires the transition probability information indicating the transition probabilities between the states from the storage unit 3. Here, the transition probability information stored in the storage unit 3 in the initial state may be information set manually, for example, by following empirical rules or by setting all probabilities in equal proportions. Alternatively, the transition probability information may be information created by collecting the temporal change information on the arousal states from drivers as experimental data in advance and by having the transition probability acquisition unit 13 to calculate the transition probabilities between the arousal states as described later. Regarding the start of second or subsequent driving, the transition probability information may be stored at the end of the previous driving and used for the next driving.

The transition probability acquisition unit 13 has a function of counting the numbers of times of the transitions of the arousal state per predetermined time based on the arousal level calculated by the arousal level calculation unit 12 and of calculating the transition probabilities from the numbers. The transition probability acquisition unit 13 transmits the calculated transition probabilities to the storage unit 3, thereby updating the transition probability information stored in the storage unit 3. The transition probability information may be updated at any time during driving, or may be updated at the end of the driving for use in the next driving.

FIG. 10 is a diagram showing an example of transitions and transition probabilities of driver's arousal states in such a case. In FIG. 10, the driver's arousal state is classified into three states: a diminished attentiveness state, a proper state, and an excited state; and the transitions between the states expected to occur during a predetermined time are indicated by arrows along with their respective probabilities. To simplify the description, the space containing three arousal states shown above is described as S={Proper state: 1, Diminished attentiveness state: 2, Excited state: 3}, and the transition probabilities shown above are described as Pij (i, j=1,2,3). Then, the transition probabilities shown in FIG. 10 can be expresses as Expression 1.

$$P = ( {P}_{ij} ) = ( \begin{matrix}{P}_{11} & {P}_{12} & {P}_{13} \\ {P}_{21} & {P}_{22} & {P}_{23} \\ {P}_{31} & {P}_{32} & {P}_{33}\end{matrix} ) = ( \begin{matrix}0.6 & 0.3 & 0.1 \\ 0.4 & 0.6 & 0.0 \\ 0.3 & 0.0 & 0.7\end{matrix} ) \qquad [ Expression 1 ]$$

For example, a driver in a proper state at a certain time stays in a proper state at a probability of P11=0.6, transitions to a diminished attentiveness state at a probability of P12=0.3, transitions to an excited state at a probability of P13=0.1 in a predetermined time. In addition, the sum of the probabilities of the state transitions after a predetermined time is normalized to 1. That is, the above transition probabilities are normalized to satisfy Expression 2.

$${\sum }_{j = 1}^{3} {P}_{ij} = 1 , ( i = 1 , 2 , 3 ) \qquad [ Expression 2 ]$$

In addition, by calculating the square of a transition probability matrix based on the characteristic of the transition probability (Markov chain), it is possible to calculate the probabilities of the states reached after twice the predetermined time from the current arousal state.

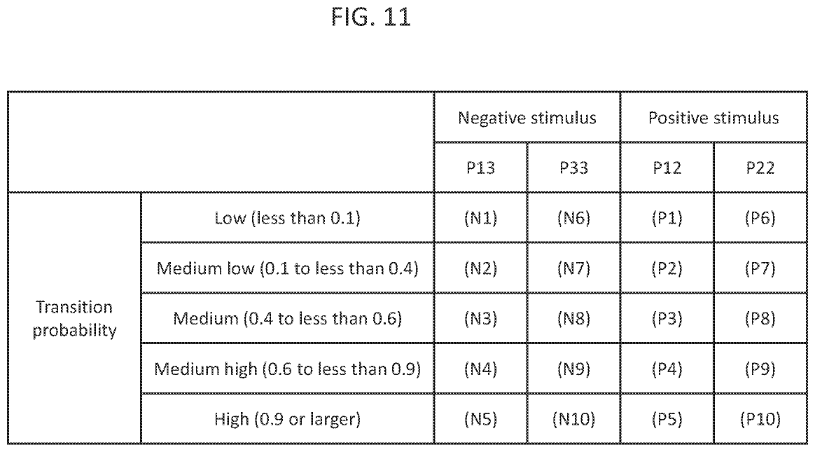

FIG. 11 is a diagram showing a concrete example of a master matrix stored in the storage unit 3 according to Embodiment 2.

The master matrix classifies the transition probabilities into five stages and holds pointer information to associate each stage with the system definition matrixes. Here, the row headings of the master matrix are classified into five stages, but as in Embodiment 1, it may be less than four stages or more than six stages as long as they are classified into multiple stages.

The system definition matrixes and the physical definition matrix are similar to those in Embodiment 1. However, it should be noted that since the transition probabilities are classified into five stages in the master matrix, the intensities of the stimuli indicated by the stimulus information held by the system definition matrixes are also classified into five stages.

The operations according to the present embodiment are the same as those of the driver assistance device 100 and the driver assistance system 1000 according to Embodiment 1, except that the stimulus determination unit 2 determines a stimulus based on the transition probability of the arousal state instead of the change rate of the arousal level over time.

After determining to give a stimulus, the stimulus determination unit 2 determines a stimulus to be given based on the stimulus correspondence information stored in the storage unit 3. For example, if a driver is in an excited state at a certain time and the probability of staying in an excited state is P33=0.7, the stimulus determination unit 2 refers to the master matrix and acquires the pointer information indicating the system definition matrix N9. The operations of acquiring the stimulus content information and the device information from the system definition matrixes and the physical definition matrix, respectively, are the same as those in Embodiment 1.

With the operations described above, the driver assistance device 100 according to Embodiment 2 determines a stronger stimulus as a stimulus to be given to a driver as the transition probability of the driver's arousal state is larger. This allows a more appropriate stimulus to be given to the driver statistically considering the change of the driver's arousal state over time.

Similarly to the driver assistance device 100 according to Embodiment 1, the driver assistance device 100 according to Embodiment 2 determines a stimulus when the arousal level exceeds a predetermined threshold, but the driver assistance device 100 according to Embodiment 2 may also give a stimulus even when the driver's arousal state is a proper state. For example, in FIG. 10, among the probabilities of transitions when the driver is in a proper state, P11=0.6 is the largest followed by P12=0.3 and P13=0.1, which is the smallest. Here, since P12>P13 holds, the driver is more likely to transition to a diminished attentiveness state than to an excited state, so that it may be determined that a positive stimulus should be given even before a threshold is exceeded. The stimulus content is determined using the stimulus correspondence information in the same manner as when a threshold is exceeded. For example, in FIG. 11, when P12=0.3 holds, the pointer information indicating the system definition matrix P2 is acquired, the information defined in the system definition matrix P2 is referred to, and the content of a stimulus is determined. Then, the driver assistance system 1000 outputs the stimulus to the driver based on the content determined by the driver assistance device 100.

As described above, a configuration to give a stimulus to a driver based on the transition probabilities even when the driver is in a proper state makes it possible to determine and give a stimulus in advance of the transition of the driver's arousal state.

### INDUSTRIAL APPLICABILITY

The driver assistance device and the driver assistance system according to the present disclosure are suitable for use in a feedback device to be provided on a vehicle.

### DESCRIPTION OF SYMBOLS

100 . . . driver assistance device,
1000 . . . driver assistance system,
1 . . . acquisition unit,
11 . . . biometric information acquisition unit,
12 . . . arousal level calculation unit,
13 . . . transition probability acquisition unit,
2 . . . stimulus determination unit,
3 . . . storage unit,
4 . . . stimulus output control unit,
200 . . . driver state detection device,
300 . . . vehicle state information acquisition device,
400 . . . vehicle surrounding information acquisition device,
500 . . . stimulus output device

1. A driver assistance device comprising:
acquisition circuitry to acquire temporal change information indicating a change of a driver's arousal state over time; and
stimulus determination circuitry to determine a stronger stimulus as a stimulus to be given to the driver as an absolute value of the change over time indicated by the temporal change information acquired by the acquisition circuitry is larger.

2. The driver assistance device according to claim 1, wherein
the acquisition circuitry includes biometric information acquisition circuitry to acquire biometric information of the driver and arousal level calculation circuitry to calculate an arousal level indicating a degree of the driver's arousal state and a change rate of the arousal level over time from the biometric information,
the acquisition circuitry acquires the change rate of the arousal level over time as the temporal change information, and
the stimulus determination circuitry determines a stronger stimulus as a stimulus to be given to the driver as the absolute value of the change rate of the arousal level over time is larger.

3. The driver assistance device according to claim 1, wherein
the acquisition circuitry acquires a transition probability of the driver's arousal state as the temporal change information, and
the stimulus determination circuitry determines a stronger stimulus as a stimulus to be given to the driver as the transition probability is larger.

4. The driver assistance device according to claim 1, wherein
when the driver's arousal state changes from a proper state to an excited state, the stimulus determination circuitry determines a stimulus to be given to the driver based on the absolute value of the change over time indicated by the temporal change information in a predetermined time that includes time spans before and after the time when the driver's arousal state changes from the proper state to the excited state, and
when the driver's arousal state changes from a proper state to a diminished attentiveness state, the stimulus determination circuitry determines a stimulus to be given to the driver based on the absolute value of the change over time indicated by the temporal change information in a predetermined time that includes time spans before and after the time when the driver's arousal state changes from the proper state to the diminished attentiveness state.

5. The driver assistance device according to claim 2, wherein
when the driver's arousal state changes from a proper state to an excited state, the stimulus determination circuitry determines a stimulus to be given to the driver based on the absolute value of the change over time indicated by the temporal change information in a predetermined time that includes time spans before and after the time when the driver's arousal state changes from the proper state to the excited state, and
when the driver's arousal state changes from a proper state to a diminished attentiveness state, the stimulus determination circuitry determines a stimulus to be given to the driver based on the absolute value of the change over time indicated by the temporal change information in a predetermined time that includes time spans before and after the time when the driver's arousal state changes from the proper state to the diminished attentiveness state.

6. The driver assistance device according to claim 3, wherein
when the driver's arousal state changes from a proper state to an excited state, the stimulus determination circuitry determines a stimulus to be given to the driver based on the absolute value of the change over time indicated by the temporal change information in a predetermined time that includes time spans before and after the time when the driver's arousal state changes from the proper state to the excited state, and
when the driver's arousal state changes from a proper state to a diminished attentiveness state, the stimulus determination circuitry determines a stimulus to be given to the driver based on the absolute value of the change over time indicated by the temporal change information in a predetermined time that includes time spans before and after the time when the driver's arousal state changes from the proper state to the diminished attentiveness state.

7. The driver assistance device according to claim 1, further comprising a storage to store stimulus correspondence information associating the change of the driver's arousal state over time with a stimulus to be given to the driver, wherein
the stimulus determination circuitry determines a stimulus to be given to the driver based on the stimulus correspondence information stored in the storage.

8. The driver assistance device according to claim 2, further comprising a storage to store stimulus correspondence information associating the change of the driver's arousal state over time with a stimulus to be given to the driver, wherein
the stimulus determination circuitry determines a stimulus to be given to the driver based on the stimulus correspondence information stored in the storage.

9. The driver assistance device according to claim 3, further comprising a storage to store stimulus correspondence information associating the change of the driver's arousal state over time with a stimulus to be given to the driver, wherein
the stimulus determination circuitry determines a stimulus to be given to the driver based on the stimulus correspondence information stored in the storage.

10. The driver assistance device according to claim 4, further comprising a storage to store stimulus correspondence information associating the change of the driver's arousal state over time with a stimulus to be given to the driver, wherein
the stimulus determination circuitry determines a stimulus to be given to the driver based on the stimulus correspondence information stored in the storage.

11. The driver assistance device according to claim 5, further comprising a storage to store stimulus correspondence information associating the change of the driver's arousal state over time with a stimulus to be given to the driver, wherein
the stimulus determination circuitry determines a stimulus to be given to the driver based on the stimulus correspondence information stored in the storage.

12. The driver assistance device according to claim 6, further comprising a storage to store stimulus correspondence information associating the change of the driver's arousal state over time with a stimulus to be given to the driver, wherein
the stimulus determination circuitry determines a stimulus to be given to the driver based on the stimulus correspondence information stored in the storage.

13. The driver assistance device according to claim 7, wherein in the stimulus correspondence information stored in the storage, the change of the driver's arousal state over time is classified into a plurality of stages, and a stage for a larger absolute value of the change of the driver's arousal state over time is associated with a stronger stimulus.

14. The driver assistance device according to claim 8, wherein in the stimulus correspondence information stored in the storage, the change of the driver's arousal state over time is classified into a plurality of stages, and a stage for a larger absolute value of the change of the driver's arousal state over time is associated with a stronger stimulus.

15. The driver assistance device according to claim 9, wherein in the stimulus correspondence information stored in the storage, the change of the driver's arousal state over time is classified into a plurality of stages, and a stage for a larger absolute value of the change of the driver's arousal state over time is associated with a stronger stimulus.

16. The driver assistance device according to claim 10, wherein in the stimulus correspondence information stored in the storage, the change of the driver's arousal state over time is classified into a plurality of stages, and a stage for a larger absolute value of the change of the driver's arousal state over time is associated with a stronger stimulus.

17. A driver assistance method comprising:
acquiring temporal change information indicating a change of a driver's arousal state over time; and
determining a stronger stimulus as a stimulus to be given to the driver as an absolute value of the change over time indicated by the acquired temporal change information is larger.

18. A driver assistance system comprising:
a driver assistance device including acquisition circuitry to acquire temporal change information indicating a change of a driver's arousal state over time and stimulus determination circuitry to determine a stronger stimulus as a stimulus to be given to the driver as an absolute value of the change over time indicated by the temporal change information acquired by the acquisition circuitry is larger; and
a stimulus output device to output the stimulus determined by the stimulus determination circuitry to the driver.

19. The driver assistance system according to claim 18, further comprising a driver state detection device to detect biometric information of the driver, wherein
the acquisition circuitry includes biometric information acquisition circuitry to acquire the biometric information detected by the driver state detection device, and arousal level calculation circuitry to calculate an arousal level indicating a degree of the driver's arousal state and a change rate of the arousal level over time from the biometric information,
the acquisition circuitry acquires the change rate of the arousal level over time as the temporal change information, and
the stimulus determination circuitry determines a stronger stimulus as a stimulus to be given to the driver as the absolute value of the change rate of the arousal level over time is larger.
